(19) United States
(12) Patent Application Publication
(10) Pub. No.: US 2010/0141870 A1
(43) Pub. Date: Jun. 10, 2010

(54) OPTICAL SHEET AND LCD APPARATUS HAVING THE SAME

(76) Inventors: Kyu-Min Choe, Suwon-si (KR); Seung-Hwan Chung, Anyang-si (KR); Jin-Sung Choi, Yongin-si (KR); Moon-Gyu Lee, Suwon-si (KR); Seong-Mo Hwang, Seongnam-si (KR); Jee-Hong Min, Seongnam-si (KR)

Correspondence Address: F. CHAU & ASSOCIATES, LLC, 130 WOODBURY ROAD, WOODBURY, NY, 11797, US

(21) Appl. No.: 12/478,373

(22) Filed: Jun. 4, 2009

(30) Foreign Application Priority Data
Dec. 5, 2008 (KR) 2008-122917

(51) Int. Cl. G02F 1/13357; G02B 5/04

(52) U.S. Cl. 349/65; 359/625

(57) ABSTRACT

Disclosed are an optical sheet and a LCD apparatus having the same. The optical sheet receives a light emitted from a light guiding plate which is disposed under the optical sheet and emits the light substantially perpendicular to a liquid crystal panel. The optical sheet comprises a first prism pattern made of a material having a first refractive index and a second prism pattern made of a material having a second refractive index which is larger than the first refractive index. The viewing angle of the LCD apparatus having the optical sheet is extended and the brightness thereof is enhanced while a gray scale inversion is reduced.

### CROSS-REFERENCE TO RELATED APPLICATION

This application claims priority under 35 U.S.C. §119 to Korean Patent Application No. 2008-122917, filed on Dec. 5, 2008 in the Korean Intellectual Property Office (KIPO), the contents of which are herein incorporated herein by reference in their entirety.

### BACKGROUND OF THE INVENTION

1. Technical Field

The present invention relates to an optical sheet and, more particularly, to an optical sheet capable of reducing a gray scale inversion and extending a viewing angle, and a liquid crystal display apparatus including the optical sheet.

2. Discussion of Related Art

Liquid crystal display (“LCD”) apparatuses have been employed in most information processing devices such as monitors, notebook computers, cellular phones and large-screen televisions since LCD apparatuses are thinner, lighter, and consume less power than conventional display devices, such as cathode ray tube (CRT) devices.

The LCD apparatus includes a liquid crystal panel that has a first substrate having a first electrode, a second substrate positioned opposite the first substrate and having a second electrode and a liquid crystal layer interposed therebetween. In the LCD apparatus, liquid crystals of the liquid crystal layer move in response to an electric field applied thereto, and thus a light transmittance thereof is changed, thereby displaying an image.

The liquid crystal material of an LCD apparatus has birefringence such that the refractive indices along a molecular long axis and along a molecular short axis are different from each other. Due to the birefringence, the refractive index, which the light experiences, depends on the viewing direction of the LCD apparatus, and this differentiates the phase of an incident light with linear polarization after passing through the liquid crystal. Therefore, the color characteristic and the amount of light in a side direction are different from those in a front direction. In particular, a twisted nematic (hereinafter, referred to TN) LCD, in which a long axis of a liquid crystal is continuously twisted from the first electrode towards the second electrode at a right angle without an electric field applied thereto, and arranged along the electric field direction perpendicular to the substrates when an electric field is applied thereto, exhibits a contrast ratio variation depending on the viewing angle, color shift, gray inversion, etc., due to the variation of the retardation of the light.

Hereinafter, with reference to FIG. 2A, gray inversion will be described in more detail.

FIG. 2A is a cross-sectional view illustrating an LCD apparatus. The LCD apparatus has a liquid crystal panel 190 and a backlight assembly 120 for illuminating the liquid crystal panel 190.

According to FIG. 2A, the liquid crystal panel 190 comprises a thin film transistor (TFT) substrate 191 having a thin film transistor and pixel electrode, an opposite substrate 193 having a common electrode. And liquid crystal is interposed between the TFT substrate 191 and the opposite substrate 193.

The backlight assembly 120 of the LCD apparatus comprises a light source 150 generating light and a light guiding plate 170 receiving the light from the light source 150, and guiding and emitting the light toward the liquid crystal panel 190. Under the light guiding plate 170, a reflecting plate 180 is disposed to reflect light leaked from the light guiding plate 170 toward a light emitting surface of the light guiding plate 170. Over the light guiding plate 170, a plurality of optical members are disposed to enhance a front brightness of the emitted light and to give uniform brightness to the display panel. The plurality of optical members comprise a diffusion sheet 111 scattering the light from the light guiding plate 170, a first prism sheet 113 having a plurality of prisms and a second prim sheet 115 having a plurality of prisms extended substantially perpendicular to the prism direction of the first prim sheet 113.

In some applications, since an LCD apparatus uses twisted nematic (TN) liquid crystals having optically anisotropic characteristics, a normal gray level is seen when the panel is viewed from a front direction, but an abnormal gray level is seen from a diagonal direction depending on viewing angle. For example, when the viewing angle exceeds a critical angle, a white image is seen as a black image while a black image is seen as a white image. This phenomenon is referred to as gray inversion.

To address gray inversion, as shown in FIG. 2B, a collimation LCD apparatus with TN liquid crystals is used to improve the viewing angle and side visibility. The collimation LCD apparatus comprises a reverse-prism sheet 230 on the light guiding plate 270 to collimate light from the backlight assembly 220 and provide the light to the liquid crystal panel 290, and a diffuse member 295 on the liquid crystal panel 290 to scatter the light in an omni-directional range.

FIG. 3 is an enlarged cross-sectional view illustrating a reverse prism sheet 230 shown in FIG. 2B. According to FIG. 3, the reverse-prism sheet 230 has a base film and a plurality of linear prisms 234 disposed under the base film and has a triangular cross section. The vertex of a prism 234 has an acute angle to enhance condensation efficiency. Since the prisms 234 of the reverse prism sheet 230 are disposed to face the light guiding plate 270, the sharpness of the prisms 234 causes some scratches on or damage to the light guiding plate 270.

### SUMMARY OF THE INVENTION

The embodiments of the present invention have been made in view of the aforementioned circumstances. According to embodiments of the present invention, an optical sheet capable of enlarging the viewing angle and preventing the light guiding plate from being damaged, and an LCD apparatus having an optical sheet are provided.

According to an embodiment of the present invention, an optical sheet includes a first prism pattern and a second prism pattern. The first prism pattern is made of a material having a first refractive index. The second prism pattern is made of a material having a second refractive index which is larger than the first refractive index. The first prism pattern and the second prism pattern are extended in the same direction, and the first prism pattern overlaps the second prism pattern. In an embodiment, the difference between the first refractive index and the second refractive index is greater than or equal to about 0.15.

An LCD apparatus, according to an embodiment of the present invention, includes the above-mentioned optical sheet.

A display apparatus in accordance with an embodiment of the present invention includes a liquid crystal panel, a light source, a light guiding plate, and an optical sheet. The liquid crystal panel displays an image. The light source generates light used to display the image. The light guiding plate receives the light from the light source and emits the light toward the liquid crystal panel. The optical sheet is disposed between the light guiding plate and the liquid crystal panel, and includes a first prism pattern and a second prism pattern. The first prism pattern is made of a material having a first refractive index and the second prism pattern is made of a material having a second refractive index which is larger than the first refractive index. The first prism pattern and the second prism pattern are extended in the same direction, and the first prism pattern overlaps the second prism pattern.

In an embodiment, the difference between the first refractive index and the second refractive index is greater than or equal to about 0.15.

According to the optical sheet and the LCD apparatus of the embodiments of the present invention, the front brightness of the display apparatus is increased and the side visibility is enhanced, thereby improving the display quality of the display apparatus. Also, the damage of the light guiding plate by the prism vertex is prevented.

### BRIEF DESCRIPTION OF THE DRAWINGS

The embodiments of the present invention will become more apparent by describing in detail exemplary embodiments thereof with reference to the accompanying drawings, in which:

FIG. 1 is a perspective view of an LCD apparatus according to an embodiment of the present invention;

FIG. 2A is a cross-sectional view illustrating a conventional LCD apparatus;

FIG. 2B is a cross-sectional view illustrating a collimation LCD apparatus;

FIG. 3 is an enlarged cross-sectional view illustrating a reverse prism sheet illustrated in FIG. 2B;

FIG. 4 is a cross-sectional view illustrating a display apparatus taken along line I-I′ of FIG. 1;

FIG. 5 is a partial cross-sectional view illustrating an optical sheet according to an embodiment of the present invention;

FIG. 6A is a graph showing the relative brightness according to viewing angle of the optical sheet illustrated in FIG. 5;

FIG. 6B is a graph showing the normalized brightness according to a viewing angle of the optical sheet illustrated in FIG. 5;

FIG. 7 is a cross-sectional view illustrating an optical sheet according to an embodiment of the present invention; and

FIG. 8 is a planar view illustrating an embossed-pattern formed on a surface of the optical sheet illustrated in FIG. 5.

### DETAILED DESCRIPTION OF EXEMPLARY EMBODIMENTS

The embodiments of the invention will now be described more fully hereinafter with reference to the accompanying drawings, in which exemplary embodiments of the invention are shown.

The present invention may, however, be embodied in many different forms and should not be construed as limited to the embodiments set forth herein. Like reference numerals may refer to like elements throughout.

It will be understood that when an element is referred to as being “on” another element, it can be directly on the other element or intervening elements may be present therebetween.

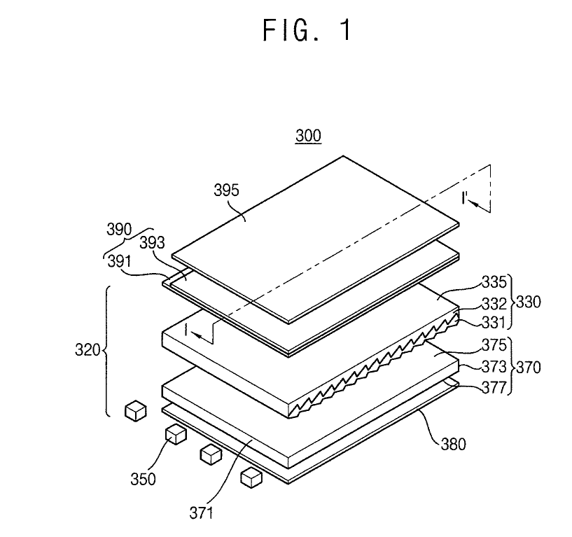

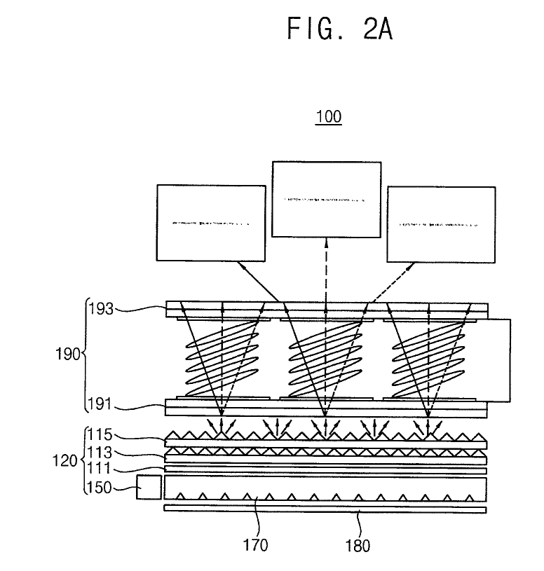

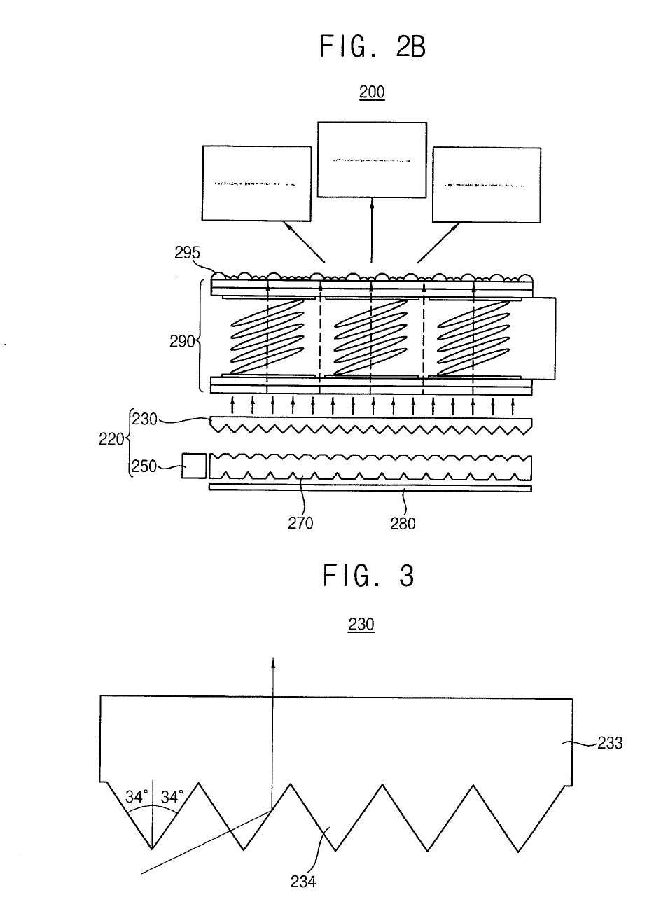

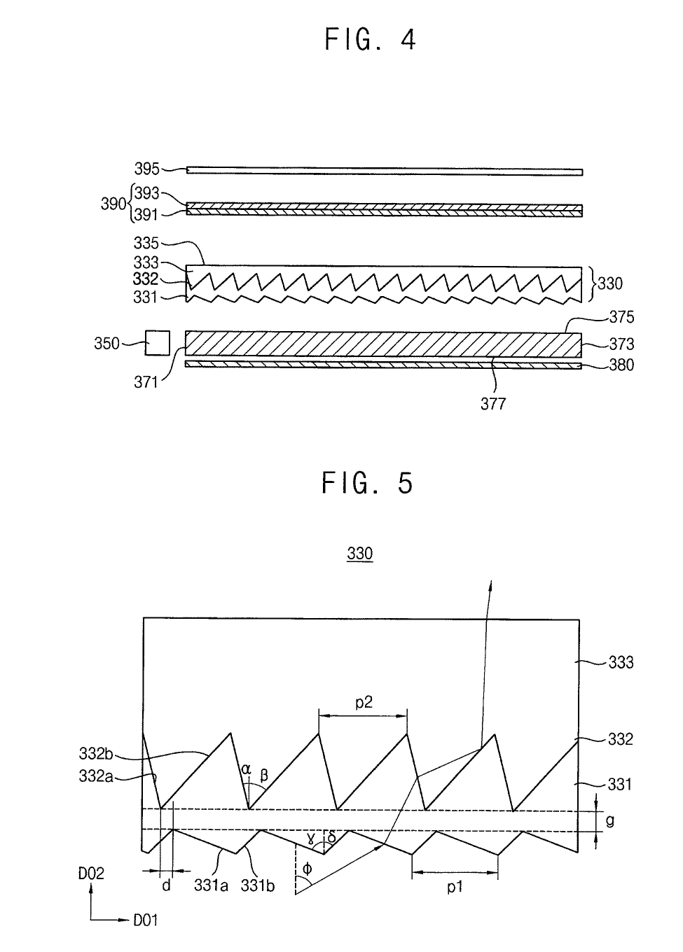

FIG. 1 is a perspective view illustrating a display apparatus 300 according to an embodiment of the present invention, and FIG. 4 is a cross-sectional view illustrating the display apparatus 300 taken along line I-I′ of FIG. 1.

Referring to FIGS. 1 and 4, the display apparatus 300 includes a liquid crystal panel 390 and a backlight assembly 320.

The liquid crystal panel 390 displays an image according to driving signals and data signals provided by an external device. The liquid crystal panel 390 includes a TFT substrate 391, an opposite substrate 393 opposing the TFT substrate 391 and is liquid crystal interposed therebetween.

The backlight assembly 320 is disposed in back of the liquid crystal panel 390 and illuminates the liquid crystal panel 390 to display an image. The backlight assembly 320 includes an optical sheet 330, a light source 350, a light guiding plate 370 and a reflector 380.

The backlight assembly 320 is an edge-type where the light source 350 is disposed at a side surface of the light guiding plate 370 along the light incident portion thereof. However, the embodiments of the present invention are not limited threreto, and the light sources 350 may also be disposed on more than one side surface of the light guiding plate 370.

The light source 350 according to an embodiment of the present invention is a point light source such as a light emitting diode (LED). The kinds of light emitting diodes are not limited to any particular type, and a white LED and a combination of red, green and blue LEDs may be used as the light source 350.

Alternatively, a linear light source such as a cold cathode fluorescent lamp (CCFL) and an external electrode fluorescent lamp (EEFL) may be used as the light source 350.

The backlight assembly 320 may have a light source reflector (not shown) disposed outside the light source 350. The light source reflector may be made of metal or plastic and the inner surface of the light source reflector may be coated with light reflective materials. The light source reflector reflects the light from the light source 350 toward the incident surface 371 of the light guiding plate 370 to improve the light efficiency of the backlight unit 320.

An optical sheet 330 is disposed between the light guiding plate 370 and the liquid crystal panel 390. The optical sheet 330 condenses light from the light guiding plate 370 to increase the front light brightness and emits light substantially perpendicular to the liquid crystal panel 390. The optical sheet 330 will be further described herein below.

The light guiding plate 370 guides the light emanated from the light source 350 and emits the light toward the liquid crystal panel 390. The light guiding plate 370 includes an incident surface 371, an opposing surface 373, an emitting surface 375 and a reflection surface 377.

The incident surface 371 and the opposing surface 373 are side surfaces of the light guiding plate 370 and are disposed to face each other. The light sources 350 are disposed along the incident surface 371 and spaced apart from each other.

The light emitting surface 375 is disposed to face the back surface of the liquid crystal panel 390 and connects the light incident surface 371 and the opposing surface 373.

The light emanated from the light source 350 is input through the light incident surface 371 of the light guiding plate 370 and provided to the inside thereof. Then, the light guiding plate 370 transports the light in a direction substantially parallel to the viewing plane of the liquid crystal panel 390 located at the upper position with respect to the light guiding plate 370. The light in some embodiments of the invention is totally reflected before it is emitted through the light emitting surface 375 giving uniform brightness along the light emitting surface 375.

The total reflection is transformed to scattered reflection in order for the light at the inside of the light guiding plate 370 to be emitted toward the liquid crystal panel 390. For this purpose, light scattering patterns may be formed on a reflection surface 377 of the light guiding plate 170.

For example, light scattering patterns may be printed by using dot-printing techniques on the reflection surface 377 opposite the light emitting surface 375. Alternatively, a print-less light guiding plate which does not require a printing process may be used. For example, a print-less type of light guiding plate may be obtained by forming grooves or linear prisms on a surface of the light guiding plate to alternate the light path at the reflection surface 377.

The light guiding plate 370 may be formed of a transparent acrylate resin such as Polymethyl methacrylate (PMMA) or Polycarbonate.

The backlight assembly 320 may include a reflector sheet 380. The reflector sheet 180 is disposed facing the light reflection surface 377 to re-input the light emitted through the light reflection surface 377 into the inside of the light guiding plate 370.

The reflector sheet 380 may be manufactured by applying silver (Ag) on a sheet made of, for example, steel use stainless (SUS), Brass, aluminum (Al), or polyethylene terephthalate (PET) and coating it with titanium (Ti) to prevent thermal deterioration caused by heat absorption.

Alternatively, the reflector sheet 380 may be obtained by dispersing micro-pores capable of scattering light in a resin sheet such as PET.

Referring to FIGS. 4 and 5, the optical sheet 330 will be further described. FIG. 4 is a cross-section view illustrating an LCD apparatus according to an embodiment of the present invention, and FIG. 5 is enlarged view illustrating the optical sheet 330.

According to FIGS. 4 and 5, the optical sheet 330 includes a double layered light condensing pattern made of materials having different refractive indices from each other and base layer 333 disposed over the light condensing pattern. The optical sheet 330 provides the light from the light emitting surface 375 of the light guiding plate 370 substantially perpendicular to the liquid crystal panel and thereby enhances a front brightness of the display apparatus.

According to an embodiment of the present invention, the light condensing pattern includes a first prism pattern 331 and a second prism pattern 332. The first prism pattern 331 and second prism pattern 332 have a plurality of prisms extended in the same direction, and the first prism pattern 331 overlaps the second prism pattern 332. For example, the first prism pattern 331 and second prism pattern 332 have a plurality of prisms extended in a direction substantially parallel to the light source arrangement disposed in a line along the one side of the light guiding plate 370.

The first prism pattern 331 is made of a material having a first refractive index n1, and the second prism pattern 332 is made of a material having a second refractive index n2. The first refractive index n1 is less than the second refractive index n2. For example, the difference between the first refractive index n1 and the second refractive index n2 is larger than about 0.15.

In other words, the refractive index of the upper second prism pattern 332 is larger than that of the lower first prism pattern 331. As a result, as shown in FIG. 5, the light passed through a first incident surface 331 a of the first prism pattern 331 is refracted and then input through a second incident 332a of the second prism pattern 332. When the incident light reaches a second opposing surface 332b of the second prism pattern 332, the light is totally reflected toward the liquid crystal panel 390 by the principle of total reflection. In order to make the total reflection sufficient at the second opposing surface 332b, the refractive index n2 of the second prism pattern 332 should be larger than the refractive index n1 of the first prism pattern 331 by more than about 0.15. Namely, Δn(=n2−n1)>0.15.

If the refractive index n1 of the first prism pattern 331 is lager than the refractive index n2 of the second prism pattern 332, then the light input through the second incident surface 332a with a predetermine incident angle is not reflected at the second opposing surface 332b but, instead, is refracted at the second incident surface 332a. Accordingly, a half luminance angle of the emitted light of the optical sheet is increased. The half luminance angle refers to a viewing angle width of angle displacement where a maximum brightness of the light becomes half the value.

Accordingly, to condense incident light in a front direction toward the liquid crystal panel, the refractive index n2 of the second prism pattern 332 should be larger than the refractive index n1 of the first prism pattern 331.

Referring to FIG. 5, the cross-section of the first prism pattern 331 includes a plurality of asymmetrical triangular shapes (e.g., scalene triangle shapes), and the first incident surface 331a, through which the emitted light from the light emitting surface 375 enters the first prism pattern 331, is formed as a gentle slope such that the surface area of the first incident surface 331a is larger than that of the opposing surface 331b. The surface area of the first incident surface 331a is extended to transport more light therethrough, thereby enhancing the light efficiency.

Alternatively, the gradient and the surface area of the first incident surface 331a may be the same as those of the first opposing surface 331b, and the cross-section of the first prism pattern 331 may include a plurality of isosceles triangles.

In FIG. 5, the vertex angles of the first prism pattern 331 are the angles between the respective first incident surfaces 331a and the first opposing surfaces 331b, and obtained by summation of an angle γ and an angle δ. The angle γ is an angle between the first incident surface 331a and a vertical line, wherein, 60°≦γ≦90°. The angle δ is an angle between the first opposing surface 331b and the vertical line, wherein, 45°≦δ≦60°. Accordingly, the vertex angle of the first prism pattern 331 is an obtuse angle from 105° to 150°.

By making the vertex angle of the first prism pattern 331 as an obtuse angle, damage to the light guiding plate 370 may be prevented. For example, a conventional reverse-prism sheet having a sharp prism shape makes a scratch on the light emitting surface 375 of the light guiding plate 370 or abrades the light guiding plate 370, but the optical sheet of the present embodiment doe not include the sharp shape to prevent damage.

Alternatively, the vertex angle of the first prism pattern 331 may be increase substantially on a level with a horizontal plane, not limited to the aforementioned range.

FIG. 8 illustrates an emboss-pattern formed on a surface of the optical sheet. To prevent damage of prisms and scratches on the light guiding plate from being severe, the first prism pattern 331 may have a hemisphere shaped emboss-pattern. Also, the emboss-pattern may be disposed on the base layer 333 of the optical sheet 330, a surface of the optical sheet facing the liquid crystal panel 390, to prevent the optical sheet 330 from adhesion with the panel 390.

The emboss-pattern of the optical sheet has a surface roughness from about 0.1 μm to about 50 μm.

The cross-section of the second prism pattern 332 according to the an embodiment of the present invention may include a plurality of asymmetrical triangular shapes. The second incident surface 332a, through which the emitted light from the first prism pattern 331 enters the second prism pattern 332, is formed steeper than the opposing surface 332b. The gradient of the second incident surface 332a is formed steep to refract a large amount of the light toward the opposing surface 332b where the total reflection takes place, thereby enlarging the amount of the light transported toward the liquid crystal panel 390 and making the brightness of the backlight assembly uniform.

Alternatively, the surface area of the second incident surface 332a may be the same as that of the second opposing surface 332b, and the cross-section of the second prism pattern 332 may include a plurality of isosceles triangles.

The vertex angle of the second prism pattern 332 is an angle between the second incident surface 332a and the second opposing surface 332b, and obtained by summation of an angle α and angle β. The angle α is an angle between the second incident surface 332a and the vertical line, and the angle β is an angle between the second opposing surface 332b and the vertical line. According to an embodiment, the angle α is less than or equal to about 20°, and the angle β is determined by factors including the angle γ, the angle α, the first refractive index n1 of the first prism pattern 331, the second refractive index n2 of the second prism pattern 332, and an elevation angle Φ of the incident light proceeding from the light guiding plate toward the optical sheet 330. That is,

$$β \approx 45 ° - \frac{α}{2} - \frac{1}{2} \cdot {sin}^{- 1} ( \frac{{n}_{1}}{{n}_{2}} \cdot sin ( γ - α - {sin}^{- 1} ( \frac{1}{{n}_{1}} \cdot sin ( φ + γ - 90 ° ) ) ) )$$

The angle β is determined by the above formula in order to emit the incident light substantially perpendicular to the liquid crystal panel 390, and the vertex angle of the second prism pattern 332, namely, α+β, is configured to an acute angle for vertical emitting distribution of the light emitted from the pattern 332.

Accordingly, the vertex angle of the second prism pattern 332 is configured to be smaller than that of the first prism pattern 331.

The first prism pattern 331 has a first pattern pitch p1 and the second prism pattern 332 has a second pattern pitch p2. The first prism pattern 331 and the second prism pattern 332 are aligned satisfying the relationship, |p1−N·p2|<p2/3 (N is a natural number smaller than 5) and −p2/3≦d≦+p2/3, that is |d|≦p2/3. The distance d shows the relation between the first prism pattern 331 and the second prism pattern 332. When the distance d has a “−” value, that means the first prism pattern 331 is aligned on the left side compared with the second prism pattern 332. When the distance d has a “+” value, that means the first prism pattern 331 is aligned on the right side compared with the second prism pattern 332. The distance d may have zero value. If the pitch p1 equals the pitch p2 and d equals zero, then the first prism pattern 331 and the second prism pattern 332 are repeated with the same pitch and the vertices of the second prism pattern 332 match with the valleys of the first prism pattern 331.

The vertices of the second prism pattern 332 may be disposed apart from the valleys of the first prism pattern 331 by a gap g, wherein, g≦p2/2. That is, the vertices of the second prism pattern 332 and the valleys of the first prism pattern 331 may be disposed apart from each other by a distance equal to half of the pattern pitch p2 of the second prism pattern 332.

Referring to FIG. 5, a transparent base layer 333 is disposed on the second prism pattern 332, and the material of the base layer 333 is the same as that of the second prism pattern 332 or may be different from the material of the second prism pattern 332.

Although not shown, the base layer 333 may be attached to a polarizer plate of the liquid crystal panel 390 by applying an adhesion layer on the base layer 333. By doing so, the liquid crystal panel and the optical sheet may be integrated for better handling and assembling.

Referring back to FIG. 4, the light guiding plate according to an exemplary embodiment of the present invention is a flat-type light guiding plate and the thickness of the incident portion is the same as that of the opposing portion.

Alternatively, the types of light guiding plate 170 may be changed. For example, a slope-type light guiding plate which has a thicker incident portion than an opposing portion may be employed to reduce a thickness of the backlight assembly.

Even though not shown, the light guiding plate 370 may include a plurality of linear prisms on the emitting surface 375, which are perpendicular to the prism direction of the condensing pattern of the optical sheet 370. By doing so, the brightness of the backlight assembly 320 can be enhanced and the half luminance angle can be reduced without adding any prism sheets.

Because the half luminance angle of light emitted from the optical sheet 330 has been narrowed, a diffuse member 395 may be disposed on the liquid crystal panel 390 to increase the viewing angle by scattering the light in multiple directions (omni-direction).

The diffuse member 395 may be configured by applying an adhesive material on the upper polarizer plate of the liquid crystal panel 390 or performing an antiglare surface treatment with a haze value above about 90%. Alternatively, a haze treatment may be performed in an internal space of the liquid crystal panel or another area not on the panel.

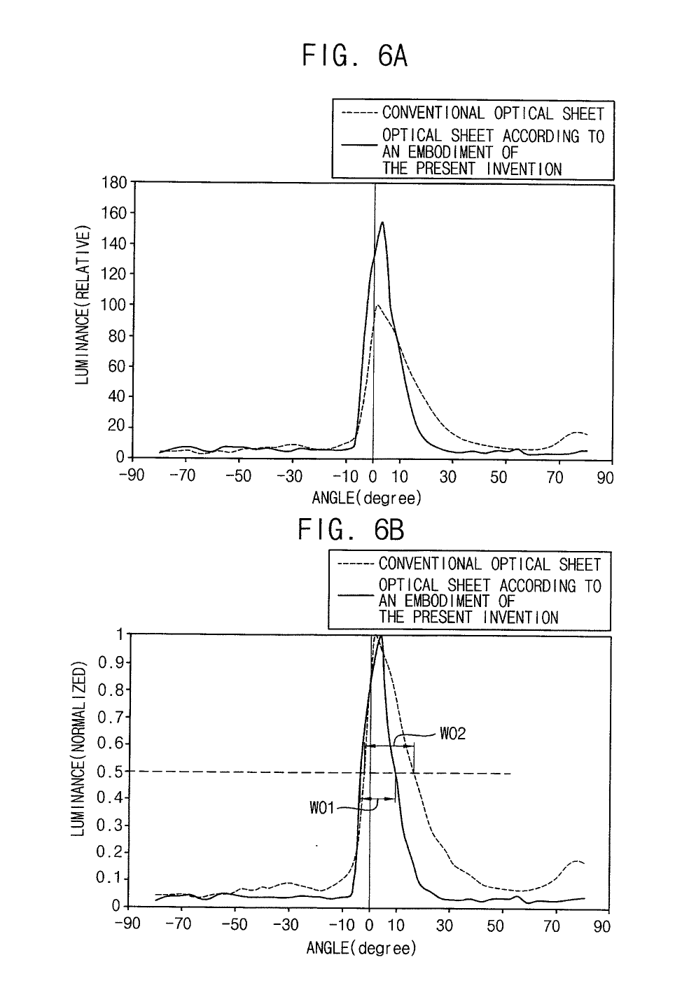

Referring to FIG. 6A, FIG. 6B and Table 1, the characteristics of the optical sheet of an embodiment of the present invention will be described.

FIG. 6A is a graph showing the relative brightness of light emitted from the optical sheet 330 according to a viewing angle, compared with a conventional reverse-prism sheet. FIG. 6B is a normalized brightness graph to show the half luminance angle width.

FIG. 6A shows the brightness distributions of the optical sheet 330 and conventional reverse prism sheet, wherein, the angle α between the second incident surface 332a and the vertical line is equal to 0°, the angle β between the second opposing surface 332b and the vertical line is equal to 24.6°, the angle γ between the first incident surface 331a and the vertical line is equal to 85°, the angle δ between the first opposing surface 331band the vertical line is equal to 55°, the first and second prism pattern pitches p1, p2 are equal to each other and equal 50 μm, distance d=0, gap g=10 μm, the first refractive index n1=1.5, and the second refractive index n2=1.7. The conventional reverse-prism sheet has a plurality of prisms with a 68° vertex angle on the back surface thereof.

In FIG. 6A, the maximum brightness of a conventional reverse-prism sheet is set to 100 for comparison, and the relative value of the optical sheet according to an embodiment of the present invention is shown therein. According to FIG. 6A, the peak value of the embodiment of the present invention is larger than that of the conventional sheet.

According to FIG. 6B, the maximum brightness is normalized to 1 and the half luminance angle width of the embodiment of the present invention is narrower than that of the conventional sheet. As illustrated in this example, when the brightness is 0.5, the half luminance angle width is in the range of about negative 10 degrees to about 10 degrees.

Table 1 shows the maximum brightness, the half luminance angle width and the emitting energy of the backlight assembly of the embodiment of the present invention, compared with a conventional sheet.

TABLE 1

| | Brightness | half luminance | emitting energy of the |
|---|---|---|---|
| | (relative value) | angle width | backlight assembly |
| Embodiment | 155 | 5.77° | 69.1% |
| Conventional | 100 | 8.52° | 70.8% |

According to Table 1, when the maximum brightness of the conventional sheet is 100, that of the optical sheet 330 is 155 so that the brightness is enhanced by about 55%. The half luminance angle width of the optical sheet 330 is 5.77°, which is narrower than that of the conventional sheet. As shown in the Table 1, the optical sheet according to an embodiment of the present invention more effectively collimates the light emitted from the light guiding plate to the liquid crystal panel, compared with the conventional sheet.

The emitting energy of the backlight assembly of the embodiment of the present invention is smaller than that of the conventional sheet. However, in the conventional sheet, because a large amount of the light is leaked, an efficient amount of the light offered to the liquid crystal panel is smaller than that of the embodiment of the present invention. Therefore, the emitting light efficiency of the optical sheet is increased in embodiment of the present invention.

That is, the optical sheet according to an embodiment of the present invention may provide the collimation LCD apparatus with a smaller half luminance angle width, a higher brightness and an enhanced light efficiency. Therefore, the TN mode LCD apparatus may display an image without the gray scale inversion. The embodiments of the present invention are not limited to a TN mode LCD, but may be adopted in other LCD apparatus to widen the viewing angle and enhance the side visibility.

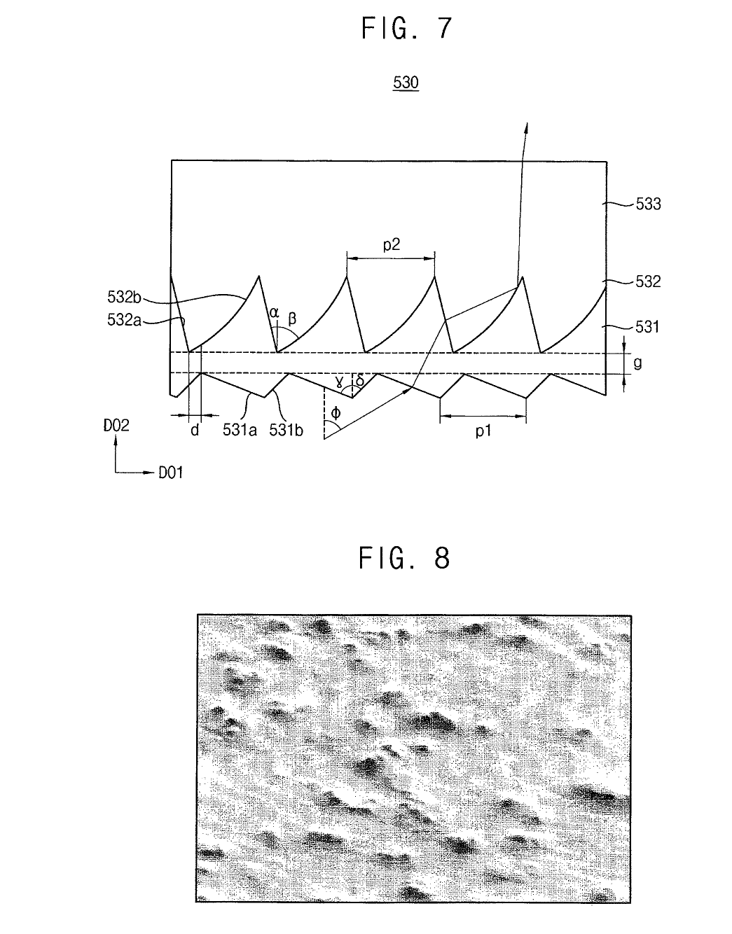

FIG. 7 is a partial cross-sectional view illustrating the optical sheet 530 according to an embodiment of the present invention.

According to FIG. 7, the optical sheet 530 is substantially the same as the optical sheet 330 shown in FIGS. 4 and 5 except for the shape of the second prism pattern 532.

In this embodiment, the optical sheet 530 may be configured to have a curved opposing surface 532b of the second prism pattern 532 in order to embody a backlight assembly having an increased brightness and a reduced half luminance angle width. The second opposing surface 532b is rounded, different from the second opposing surface 332b of FIG. 5. As a result, the light reflected at the second opposing surface 532b is provided substantially perpendicular to the liquid crystal panel.

Alternatively, the second opposing surface 532b may be configured to have a polygonal shape composed of several surfaces being tangent to the curved surface.

An LCD apparatus according to an embodiment of the present invention is substantially the same as the LCD apparatus 300 of FIGS. 4 and 5, except for the optical sheet 530 shown in FIG. 7.

In the LCD apparatus having the optical sheet 530, the second opposing surface 532b is curved, thereby offering the light with a narrower half luminance angle to the liquid crystal panel. Therefore, the LCD apparatus having the optical sheet 530 may have a wide viewing angle and high side visibility without gray scale inversion.

According to the optical sheet of the embodiments of the present invention and the LCD apparatus having the same, the optical sheet receives the light from the light guiding plate and offers the light substantially perpendicular to the liquid crystal panel, thereby preventing the gray scale inversion and damage of the light guiding plate by the condensing pattern thereof. Therefore, the embodiments of the present invention permit enhancement of the display image quality of the collimating LCD apparatus.

Although exemplary embodiments of the present invention have been described, it is understood that the present invention should not be limited to these exemplary embodiments but various changes and modifications can be made by one of ordinary skill in the art within the spirit and scope of the present invention as hereinafter claimed.

What is claimed is:

1. An optical sheet comprising:
a first prism pattern having a first refractive index; and
a second prism pattern having a second refractive index larger than the first refractive index,
wherein the first prism pattern and the second prism pattern extend in the same direction, and the first prism pattern overlaps the second prism pattern.

2. The optical sheet of claim 1, wherein the difference between the first refractive index and the second refractive index is greater than or equal to about 0.15.

3. The optical sheet of claim 1, wherein a vertex angle of the first prism pattern is larger than a vertex angle of the second prism pattern.

4. The optical sheet of claim 3, wherein the vertex angle of the first prism pattern is an obtuse angle.

5. The optical sheet of claim 3, wherein opposite sides of a vertex of the second prism pattern have a different slope from each other.

6. The optical sheet of claim 5, wherein one of the opposite sides of the vertex of the second prism pattern comprises a curved line.

7. The optical sheet of claim 5, wherein opposite sides of a vertex of the first prism pattern have a different slope from each other.

8. The optical sheet of claim 1, wherein the first prism pattern has a first pattern pitch p1 and the second prism pattern has a second pattern pitch p2,
wherein, |p1−N·p2|<p2/3 and N is a natural number less than 5.

9. The optical sheet of claim 8, wherein the first pattern pitch p1 is equal to the second pattern pitch p2.

10. The optical sheet of claim 8, wherein a vertex of the second prism pattern is disposed apart from a valley of the first prism pattern by a gap g,
wherein, g≦p2/2.

11. A display apparatus comprising:
a liquid crystal panel;
a light source generating light used to display an image;
a light guiding plate positioned to receive the light from the light source and emit the light toward the liquid crystal panel; and
an optical sheet disposed between the light guiding plate and the liquid crystal panel, the optical sheet comprising;
a first prism pattern having a first refractive index; and
a second prism pattern having a second refractive index larger than the first refractive index,
wherein, the first prism pattern and the second prism pattern extend in the same direction, and the first prism pattern overlaps the second prism pattern.

12. The display apparatus of claim 11, wherein the difference between the first refractive index and the second refractive index is greater than or equal to about 0.15.

13. The display apparatus of claim 11, wherein a vertex angle of the first prism pattern is an obtuse angle and larger than a vertex angle of the second prism pattern.

14. The display apparatus of claim 13, wherein a cross section of the second prism pattern includes a plurality of scalene triangle shapes.

15. The display apparatus of claim 14, wherein one of the opposite sides of a vertex of the second prism pattern comprises a curved line.

16. The display apparatus of claim 14, wherein opposite sides of a vertex of the first prism pattern have a different slope from each other.

17. The display apparatus of claim 11, the first prism pattern has a first pattern pitch pI and the second prism pattern has a second pattern pitch p2,
wherein, |p1−N·p2|<p2/3 and N is a natural number less than 5.

18. The display apparatus of claim 17, wherein the first pattern pitch p1 is equal to the second pattern pitch p2.

19. The display apparatus of claim 11, wherein light emitted from the optical sheet is incident substantially perpendicular to the liquid crystal panel and a diffusive member is disposed on the liquid crystal panel to scatter the light in multiple directions.

20. The display apparatus of claim 11, wherein the light source includes a light emitting diode or a lamp and is installed at one or more side edges of the light guiding plate.
